(19) United States
(12) Patent Application Publication
(10) Pub. No.: US 2023/0066944 A1
(43) Pub. Date: Mar. 2, 2023

(54) Method For Flotation Of A Phosphate-Containing Ore

(71) Applicant: BASF SE, Ludwigshafen am Rhein (DE)

(72) Inventors: Susan Carvalho, Ludwigshafen (DE); Alexej Michailovski, Ludwigshafen (DE); Rostislav Kamkin, Moscow (RU); Bettina Sobotka, Ludwigshafen (DE)

(21) Appl. No.: 17/791,090

(22) PCT Filed: Jan. 7, 2021
(86) PCT No.: PCT/EP2021/050207

§ 371 Date: Jul. 6, 2022

(30) Foreign Application Priority Data
Jan. 9, 2020 (RU) PCT/RU2020/000001

(51) Int. Cl. B03D 1/02; B03D 1/008; B03D 1/004

(52) U.S. Cl. CPC B03D 1/021; B03D 1/008; B03D 1/0046; B03D 2201/06; B03D 2203/06

(57) ABSTRACT

The invention relates to a method for manufacturing a concentrate enriched in a phosphate mineral content from an ore, which contains a phosphate mineral and a non-phosphate mineral, by a flotation, which method comprises the step of adding a surfactant system comprising (A) a fatty acid, (B) a blend of ethoxylated and non-ethoxylated alcohols, which is obtainable by blending (i) a reaction product of a first C₁₂-C₁₆ aliphatic alcohol having an average degree of branching of 1.9 to 3.5 and 10 to 20 equivalents of ethylene oxide, and (ii) a second C₁₂-C₁₆ aliphatic alcohol having an average degree of branching of 1.9 to 3.5, wherein the amount of (i) is 80 to 95 wt. % and the amount of (ii) is 5 to 20 wt. % and wt. % is based on the overall weight of the mixture of ethoxylated and non-ethoxylated alcohols, to a prepared aqueous pulp of the ore and optionally one or more flotation auxiliaries to obtain an aqueous mixture. Furthermore, a use of the surfactant system as flotation collector is disclosed.

The present invention relates to a method for manufacturing a concentrate enriched in phosphate mineral content from an ore, which contains a phosphate mineral and a non-phosphate mineral, by a flotation using a surfactant system comprising a fatty acid and a blend of a reaction product of a first C₁₂-C₁₆ aliphatic isoalcohol and ethylene oxide and a second C₁₂-C₁₆ aliphatic isoalcohol. Further embodiments are a use of the surfactant system as a flotation collector and the blend as such.

A rising demand for phosphorus as a key ingredient of agricultural fertilizers requires continuous access to a supply of a phosphate mineral through mining activities. A phosphate source for a mining activity is typically an ore, which contains a phosphate mineral and a non-phosphate mineral. Phosphate sources which are easiest to exploit also are mostly exhausted first. Thus, a shift towards ores with more complex mineralogy as phosphate sources is necessary. In other words, the quality of ores is decreasing. This leads to more sophisticated requirements at beneficiation of the ore as a phosphate source. Froth flotation is a process employed for beneficiation of ores.

WO 2016-041916 discloses the use of branched fatty alcohol-based compounds selected from the group of fatty alcohols with 12-16 carbon atoms having a degree of branching of 1 to 3 and their alkoxylates with a degree of ethoxylation of up to 3 as secondary collectors for the froth flotation of non-sulfidic ores in combination with a primary collector selected from the group of amphoteric and anionic surface active compounds. Example 2 discloses inter alia a froth flotation of an apatite-containing ore with an amphoteric N-[2-hydroxy-3-(C₁₂-C₁₆-alkoxy)propyl]N-methyl glycinate and a reaction product of an Exxal-13-alcohol having a degree of branching of 3 with 1.5 equivalents ethylene oxide or said amphoteric collector and a reaction product of MarlipalO-alcohol having a degree of branching of 2.2 with 1.5 equivalents ethylene oxide. Example 4 discloses inter alia a froth flotation of an apatite-containing ore with an amphoteric N-[2-hydroxy-3-(C₁₂-C₁₆-alkoxy)propyl]N-methyl glycinate and Exxal-13-alcohol having a degree of branching of 3.

WO 2017-162563 discloses secondary collector mixtures containing at least one compound (i) selected from the group of branched fatty alcohols with 12-16 carbon atoms having a degree of branching of 1 to 3.5 and their alkoxylates with a degree of ethoxylation of up to 4 and at least one compound (ii) selected from the group of alkoxylates of nonionic hydrocarbon compounds with a degree of ethoxylation of higher than 3 and carbohydrate-based surfactants, wherein if both compounds (i) and (ii) are ethoxylated alcohols, the mixture has a bimodal degree of ethoxylation distribution. Further disclosed are the use of the compound (ii) as an emulsifier for compound (i) in a liquid, collector compositions containing the secondary collector mixtures together with a primary collector that is an amphoteric or anionic surface-active compound and a use of the above compositions in a process for flotation of non-sulfidic ores. Example 1 discloses a froth flotation of an apatite-containing ore with an acylglycide and a reaction product of Exxal-13-alcohol having a degree of branching of 3 with 5 equivalents of ethylene oxide as well as a froth flotation of an apatite-containing ore with an acylglycide and a 1:1 mixture of a reaction product of Exxal-13-alcohol having a degree of branching of 3 with 1.5 equivalents ethylene oxide and a reaction product of Exxal-13-alcohol having a degree of branching of 3 with 8.5 equivalents ethylene oxide.

WO 2018-197476 discloses a collector composition for beneficiation of phosphates from phosphate containing ore sand, its use in flotation processes and a method for beneficiation using the collector composition. Example 1 discloses inter alia a froth flotation of a phosphate-containing ore with oleic acid and a reaction product of an isotridecanol with 3 equivalents ethylene oxide and a froth flotation of a phosphate-containing ore with oleic acid, a reaction product of an isotridecanol with 3 equivalents ethylene oxide and dioctyl sulfosuccinate. Example 2 discloses a froth flotation of a phosphate-containing ore with oleic acid and either a reaction product of an isotridecanol with 3 equivalents ethylene oxide, a 4:1 or a 1:1.5 mixture of a reaction product of an isotridecanol with 3 equivalents ethylene oxide and a reaction product of an isotridecanol with 10 equivalents ethylene oxide. Example 3 discloses a froth flotation of a phosphate-containing ore with tall oil fatty acids and either a reaction product of an isotridecanol with 3 equivalents of ethylene oxide, a 1:1 mixture of a reaction product of an isotridecanol with 3 equivalents ethylene oxide and a reaction product of an isotridecanol with 10 equivalents ethylene oxide or a reaction product of 10 equivalents ethylene oxide. Example 4 discloses a froth flotation of a phosphate-containing ore with soybean fatty acid and either a reaction product of an isotridecanol with 3 equivalents ethylene oxide, a 1.5:1 mixture or a 1:1.5 mixture of a reaction product of an isotridecanol with 3 equivalents ethylene oxide and a reaction product of an isotridecanol with 10 equivalents ethylene oxide or a reaction product of an isotridecanol with 10 equivalents ethylene oxide.

There is still a need for improved methods for flotation of ores containing a phosphate mineral and a non-phosphate mineral. On one side, a loss of phosphate mineral in the flotation process should be avoided, i.e. a high recovery, and on the other side, a content of the non-phosphate mineral should be decreased in a concentrate enriched in a phosphate mineral, i.e. selectivity. An important aspect in processing an ore, which contains a phosphate mineral and a non-phosphate mineral, by froth flotation remains the differentiation between the phosphate mineral apatite (Ca₅(PO₄)₃(F, Cl, OH)) on the one side and the non-phosphate mineral calcite (CaCO₃) or dolomite (CaMg[CO₃]₂) on the other side. All three are calcium-containing minerals and adsorb collectors containing carboxylic acid groups, e.g. fatty acids, with a similar affinity. A better recovery in combination with a comparable or a better selectivity reduces phosphate mineral losses in the tailings and leads to economic benefits.

It is an object of the present invention to provide a method for manufacturing a concentrate enriched in phosphate mineral content with a high recovery of phosphate mineral from the applied ore and a low content of non-phosphate mineral. At the same time, it is an advantage if the chemicals applied in the method can economically be manufactured. A possibility of reduction of the dosage of the applied chemicals at a maintained recovery and/or selectivity is an advantage. A short process time at the method for manufacturing is a further desirable property.

The object is achieved, according to the invention, by a method for manufacturing a concentrate enriched in phosphate mineral content from an ore, which contains a phosphate mineral and a non-phosphate mineral, by a flotation, which method comprises the step of
(c) adding a surfactant system comprising components
   (A) a fatty acid,
   (B) a blend of ethoxylated and non-ethoxylated alcohols, which is obtainable by blending components
      (i) a reaction product of a first C₁₂-C₁₆ aliphatic alcohol having an average degree of branching of 1.9 to 3.5 and 10 to 20 equivalents of ethylene oxide, and
      (ii) a second C₁₂-C₁₆ aliphatic alcohol having an average degree of branching of 1.9 to 3.5,
      wherein the amount of (i) is 80 to 95 wt. % and the amount of (ii) is 5 to 20 wt. % and wt. % is based on the overall weight of the mixture of ethoxylated and nonethoxylated alcohols,
   to a prepared aqueous pulp of the ore and optionally one or more flotation auxiliaries to obtain an aqueous mixture.

Preferably, the method for manufacturing a concentrate enriched in phosphate mineral content from an ore, which contains a phosphate mineral and a non-phosphate mineral, by a flotation, comprises the steps of
(a) providing the ore, which contains a phosphate mineral and a non-phosphate mineral,
(b) preparing from the provided ore by addition of water and optionally one or more flotation auxiliaries an aqueous pulp,
(c) adding a surfactant system comprising components
   (A) a fatty acid,
   (B) a blend of ethoxylated and non-ethoxylated alcohols, which is obtainable by blending components
      (i) a reaction product of a first C₁₂-C₁₆ aliphatic alcohol having an average degree of branching of 1.9 to 3.5 and 10 to 20 equivalents of ethylene oxide, and
      (ii) a second C₁₂-C₁₆ aliphatic alcohol having an average degree of branching of 1.9 to 3.5,
      wherein the amount of (i) is 80 to 95 wt. % and the amount of (ii) is 5 to 20 wt. % and wt. % is based on the overall weight of the mixture of ethoxylated and nonethoxylated alcohols,
   to a prepared aqueous pulp of the ore and optionally one or more flotation auxiliaries to obtain an aqueous mixture,
(d) aerating the aqueous mixture in a flotation cell to generate a froth, which contains the concentrate enriched in phosphate mineral content.

The steps (a), (b), (c) and (d) describe in more detail a direct flotation. Direct flotation means herein that the froth contains the desired concentrate enriched in phosphate mineral content.

Preferably, steps (a) to (d) are followed by a step (e), which is
(e) removing the generated froth from the flotation cell.

The ore, which contains a phosphate mineral and a non-phosphate mineral, is for example from an igneous deposit or from a sedimentary deposit. The ore can also be termed phosphoric rock or phosphoric ore. The desired component of the ore is the phosphate mineral. A phosphate mineral is for example apatite (Ca₃(PO₄)₃(F, Cl, OH)), hydroxylapatite (Ca₃(PO₄)₃OH), fluorapatite (Ca₃(PO₄)₃F), chlorapatite (Ca₃(PO₄)₃Cl), frankolite (Ca_{10-a-b}Na,Mg_{b}(PO₄)₆₋ₓ(CO₃)_{x-y-z}(CO₃F)_{y}(SO₄)_{z}F₂), lazulite (Mg, Fe)Al₂(PO₄)₂(OH)₂), monazite ((Ce, La, Y, Th)PO₄), pyromorphite (Pb₅(PO₄)₃Cl), strengite (FePO₄.2H₂O), triphylite (Li(Fe, Mn)PO₄), turquoise (CuAl₆(PO₄)₄(OH)₈.5H₂O), varisite (AlPO₄.2H₂O), vauxite (FeAl₂(PO₄)₂(OH)₂.6H₂O), vivanite (Fes(PO₄)₂.8H₂O), wavelite (Al₃(PO₄)₂(OH)₃.5H₂O). Preferably, the phosphate mineral is a calcium-containing phosphate. Very preferably, the phosphate mineral is apatite, hydroxylapatite, fluorapatite, chlorapatite or frankolite. Particularly, the phosphate mineral is apatite, hydroxylapatite, fluorapatite, chlorapatite. Very particularly, the phosphate mineral is fluorapatite.

The non-phosphate mineral is herein an undesired component of the ore. The non-phosphate mineral can herein also be termed as impurity or gangue. A non-phosphate mineral is for example a carbonate mineral different to frankolite, a silicate mineral, magnetite (Fe₃O₄) or scheelite (Ca(WO₄)). A carbonate mineral different to frankolite is for example calcite (CaCO₃), dolomite (CaMg(CO₃)₂) or hydrotalcite (Al₂Mg₆(OH)₁₆CO₃.4H₂O). A content of a carbonate mineral can be calculated and stated as a formal CO₂ content, typically as weight percentage. A silicate mineral is for example a mica, a clay, quartz (SiO₂) or feldspar ((Ba, Ca, Na, K, NH₄)(Al, B, Si)₄O₃).

Flotation relates to the separation of minerals based on differences in their adsorption to surfactants and the different ability of the formed mineral-surfactant-adsorbate to adhere to gaseous bubbles, particularly air bubbles. The aim of a flotation as an ore-processing operation is to selectively separate components of the ore. At a flotation, a differentiation between direct and reverse flotation is possible. A direct flotation refers to methods where the desired component of the ore is collected in the froth and the undesired component of the ore remains in the slurry of a flotation cell as cell product. A reverse flotation—also called inverse flotation—refers to methods where the undesired component of the ore is collected in the froth and the desired component of the ore remains in the slurry of a flotation cell as cell product. The concentrate enriched in phosphate mineral content is the flotation product. In case of a direct flotation, the concentrate enriched in phosphate mineral content is in the froth. In case of a reverse flotation, the concentrate enriched in phosphate mineral content is the cell product.

The content of the phosphate mineral in the obtained concentrate after the enrichment via flotation is calculated as a formal P₂O₅ content. The content of the phosphate mineral in the obtained concentrate is stated as a weight percentage of the formal P₂O₅ content based on the dry weight of the obtained concentrate. The content of the phosphate mineral in the obtained concentrate is also called grade. Preferably, the content of the phosphate mineral in the obtained concentrate is above 30 wt. % P₂O₅ (=30% by weight of P₂O₅), more preferably above 32 wt. %, very preferably above 34 wt. % and below 42 wt. %, particularly above 35 wt. % and below 41 wt. %, more particularly above 36 wt. % and below 40 wt. % and especially above 37 wt. % and below 40 wt. %. Recovery is the weight percentage of the amount of obtained phosphate mineral calculated as a formal P₂O₅ content based on the overall weight of desired phosphate mineral calculated as a formal P₂O₅ content originally contained in the dry ore, which contains a phosphate mineral and a non-phosphate mineral. The relationship between the content of the phosphate mineral in the obtained concentrate versus the recovery is a measure for the selectivity of the method for manufacturing a concentrate enriched in phosphate mineral content. A higher selectivity indicates a higher efficiency or performance of the method.

The step (a) of providing an ore comprises for example also a crushing or a grinding respectively milling of the ore. In case of an ore from an igneous deposit, the step of providing the ore comprises for example also a crushing of the ore and a grinding respectively milling of the ore. A grinding of the ore occurs for example in a ball mill. In case of an ore from a sedimentary deposit, the step of providing the ore comprises for example a crushing of the ore, particularly a crushing of the ore and a wet grinding of the ore. Preferably, the step (a) of providing of the ore results in ore particles, which have a particle size allowing 60 wt. % to 100 wt. % of the particles based on the overall weight of the particles to pass a 200 μm sieve, typically a steel mesh sieve, as measured by standard dry sieving, more preferably 60 wt. % to 100 wt. % of the particles pass a 200 μm steel mesh sieve and 30 wt. % to 60 wt. % by weight of the particles pass a 71 μm sieve, very preferably 70 wt. % to 90 wt. % of the particles pass a 200 μm steel mesh sieve and 30 wt. % to 50 wt. % of the particles pass a 71 μm sieve.

The step (a) of providing an ore comprises also for example a removing of a ferromagnetic component. Especially, if the ore, which contains a phosphate mineral and a non-phosphate mineral, contains a ferromagnetic component. A ferromagnetic component if for example the nonphosphate mineral magnetite. The removing of a ferromagnetic component occurs preferably after a crushing or grinding of the ore. Preferably, the removing of ferromagnetic component occurs as a wet magnetic separation.

The ore, which contains a phosphate mineral and a non-phosphate mineral, contains for example above 4 wt. % P₂O₅, preferably above 5 wt. % and below 15 wt. % P₂O₅, more preferably above 6 wt. % and below 13 wt. % P₂O₅, very preferably above 7 wt. % and below 11 wt. % P₂O₅. Preferably, these content ranges of formal P₂O₅ are present in the ore as fluorapatite. The ore, which contains a phosphate mineral and a non-phosphate mineral, contains for example a nonphosphate mineral, which is a carbonate mineral different to frankolite, preferably calcite or dolomite, very preferably calcite and dolomite. The content of the non-phosphate mineral, which is a carbonate mineral different to frankolite, is preferably above 5 wt. % and below 20 wt. % CO₂, more preferably above 7 wt. % and below 17 wt. % CO₂, very preferably above 9 wt. % and below 14 wt. % CO₂. Preferably, these content ranges of formal CO₂ are present in the ore as calcite or dolomite, very preferably as calcite and dolomite.

The surfactant system in the method acts as a collector for flotation, particularly as a collector for froth flotation.

A fatty acid is a single fatty acid or a mixture of different fatty acids. The fatty acid is preferably a non-aromatic and non-cyclic carboxylic acid, which is saturated or unsaturated, with at least 12 carbon atoms, more preferably with 12 to 22 carbon atoms, very preferably with 14 to 20 carbon atoms and particular preferably with 16 to 18 carbon atoms. The fatty acid is for example lauric acid, myristic acid, palmitic acid, palmitoleic acid (Z/E), margaric acid, stearic acid, oleic acid, elaidic acid, linoleic acid, linolenic acid, arachidic acid, arachidonic acid, behenic acid or erucic acid. Preferably, the fatty acid is obtained from a vegetable source or an animal source. A vegetable source is for example coconut oil, palm oil, rapeseed oil, rice bran oil, soybean oil, sunflower oil or tall oil. An animal source is for example tallow oil or fish oil. Tall oil in its crude version is a mixture of fatty acids, resin acids and unsaponifiable matter obtained as a byproduct at the preparation of sulfate cellulose from wood, for example from a resinous wood, preferably pine or spruce, very preferably pine, particularly northern pine. Distillation of the crude tall oil allows to obtain fractions enriched with tall oil fatty acids. A typical composition of a first quality fraction enriched in tall oil fatty acids has a content of at least 97 wt. % of fatty acids and the fatty acids themselves are linoleic acid and other conjugated fatty acids with 18 carbon atoms (45 to 65 wt. % based on the overall weight content of fatty acids), oleic acid (25 to 45 wt. % based on the overall weight content of fatty acids), octadeca-5,9,12-triene acid (5 to 12 wt. % based on the overall weight content of fatty acids) and saturated fatty acids (1 to 3 wt. % based on the overall weight content of fatty acids). Preferably, the fatty acid is a mixture of different fatty acids. More preferably, the fatty acid is tall oil fatty acids. Very preferably, the fatty acid is distilled tall oil fatty acids. Particularly, the fatty acid is distilled tall oil fatty acids obtained from pine. Very particularly, the fatty acid is distilled tall oil fatty acids obtained from northern pine.

The first C₁₂-C₁₆ aliphatic alcohol and the second C₁₂-C₁₆ aliphatic alcohol are understood herein as not being substituted, for example not being substituted by a halogen atom or not being substituted by a further OH-group.

The first C₁₂-C₁₆ aliphatic alcohol is a single C₁₂-C₁₆ aliphatic alcohol molecule or a mixture of different C₁₂-C₁₆ aliphatic alcohol molecules. The first C₁₂-C₁₆ aliphatic alcohol preferably is a single C₁₂-C₁₄ aliphatic alcohol molecule or a mixture of different C₁₂-C₁₄ aliphatic alcohol molecules. The first C₁₂-C₁₆ aliphatic alcohol preferably is a single C₁₃ aliphatic alcohol molecule (an isotridecanol) or a mixture of different C₁₃ aliphatic alcohol molecules (isotridecanols). It is noted that an aliphatic alcohol can differ by the amount of carbon atoms or by the branching pattern of different aliphatic alcohol molecules. The latter applies also for those molecules having the same molecular formula.

Preferred is a method, wherein the first C₁₂-C₁₆ aliphatic alcohol is a C₁₃ aliphatic alcohol (isotridecanol).

The second C₁₂-C₁₆ aliphatic alcohol is a single C₁₂-C₁₆ aliphatic alcohol molecule or a mixture of different C₁₂-C₁₆ aliphatic alcohol molecules. The second C₁₂-C₁₆ aliphatic alcohol preferably is a single C₁₂-C₁₄ aliphatic alcohol molecule or a mixture of different C₁₂-C₁₄ aliphatic alcohol molecules. The second C₁₂-C₁₆ aliphatic alcohol preferably is a single C₁₃ aliphatic alcohol molecules (an isotridecanol) or a mixture of different C₁₃ aliphatic alcohol molecules (isotridecanols).

Preferred is a method, wherein the second C₁₂-C₁₆ aliphatic alcohol is a C₁₃ aliphatic alcohol (isotridecanol).

Preferably, the first C₁₂-C₁₆ aliphatic alcohol and the second C₁₂-C₁₆ aliphatic alcohol are the same C₁₂-C₁₆ aliphatic alcohol, more preferably the same C₁₂-C₁₄ aliphatic alcohol and very preferably the same C₁₃ aliphatic alcohol (isotridecanol).

Preferred is a method, wherein the first C₁₂-C₁₆ aliphatic alcohol and the second C₁₂-C₁₆ aliphatic alcohol are the same C₁₂-C₁₆ aliphatic alcohol.

The average degree of branching of the first C₁₂-C₁₆ aliphatic alcohol or the second C₁₂-C₁₆ aliphatic alcohol refers to the branching in the carbon backbone of the alcohol, i.e. at the dodecyl, tridecyl, tetradecyl, pentadecyl or hexadecyl part. For each alcohol molecule, the degree of branching is defined as the number of carbon atoms, which are bound to three further carbon atoms plus two times the number of carbon atoms which are bound to four further carbon atoms. The average degree of branching of a mixture of alcohols is the sum of all degrees of branching divided by the number of all single alcohol molecules. In case of a mere hydrogen-substituted carbon backbone, the degree of branching of each alcohol molecule is similar to the number of methyl groups minus one and the average degree of branching is the mean number of methyl groups minus one. The degree of branching is determined for example by NMR methods. This can be carried out through analysis of the carbon backbone with suitable NMR coupling methods (COSY, DEPT, INADEQUATE) followed by a quantification via ¹³C NMR with relaxation reagents. In case of a mere hydrogen-substituted carbon backbone, a ¹H NMR quantification of the methyl groups is possible, for example by dividing the signal area of the protons of the methyl groups by three and putting it into relation with the signal area of the protons of the CH₂—OH divided by two. In case of a single C₁₂-C₁₆ aliphatic alcohol molecule, the average degree of branching can only be an integer, i.e. 2 or 3. In case of a mixture of different alcohol molecules, the average degree of branching does not have to be an integer. In case of a mixture of different alcohol molecules, the single alcohol molecules have preferably predominantly a degree of branching of 2 or 3. Preferably, the average degree of branching of the first C₁₂-C₁₆ aliphatic alcohol is between 1.9 and 2.6 or between 2.8 to 3.4. More preferably, the average degree of branching of the first C₁₂-C₁₆ aliphatic alcohol is between 2.0 and 2.5 or between 2.9 to 3.3. Very preferably, the average degree of branching of the first C₁₂-C₁₆ aliphatic alcohol is between 2.0 and 2.5. Particularly, the average degree of branching of the first C₁₂-C₁₆ aliphatic alcohol is between 2.1 and 2.4. Preferably, the average degree of branching of the second C₁₂-C₁₆ aliphatic alcohol is between 1.9 and 2.6 or between 2.8 to 3.4. More preferably, the average degree of branching of the second C₁₂-C₁₆ aliphatic alcohol is between 2.0 and 2.5 or between 2.9 to 3.3. Very preferably, the average degree of branching of the second C₁₂-C₁₆ aliphatic alcohol is between 2.0 and 2.5. Particularly, the average degree of branching of the second C₁₂-C₁₆ aliphatic alcohol is between 2.1 and 2.4.

Preferred is a method, wherein the average degree of branching of the first C₁₂-C₁₆ aliphatic alcohol is between 2.0 and 2.5.

Preferred is a method, wherein the average degree of branching of the second C₁₂-C₁₆ aliphatic alcohol is between 2.0 and 2.5

WO 2001-36356 discloses in its example 2 a preparation of an isotridecanol with an average degree of branching of 2.27. A butene mixture, e.g. an unsaturated C4 fraction of a steamcracker output, is subjected to a catalytic oligomerization, which results in a blend of unreacted butene and branched olefins containing multiples of 4 in carbon atom number. They have very different boiling points, which makes it easy to nearly quantitatively separate C4, C8, C12 and C16 fractions from another. Accordingly, C11 or C13 alkenes are hard to be found in the C12 fraction. The C12 fraction is subjected to hydroformylation. The hydroformylation of a C12 alkene results in a C13 alcohol independent of a branching degree of said alkene. The butene mixture contains 1-butene, 2-butene and a minor amount of isobutene. Its trimerization leads to numerous branching patterns, however all of them lead to a molecular formula of C₁₂H₂₄ and correspondingly all hydroformylation products will have the formula of C₁₃H₂₇OH. The C12 alkene in question is mostly an alpha-alkene and sometimes a beta-alkene, i.e. if a 2-butene molecule has built the unsaturated end of the C12 alkene. A hydroformylation of an alpha alkene can take place both at the primary C1-carbon atom or at the secondary C2-carbon atom of the alpha alkene. A slight, sterically caused preference for the primary C1-carbon atom is evident. For a beta alkene, the relevant C2-carbon atom and C3-carbon atom are both secondary carbon atoms and hence no practical preference is observed. This means that the hydroformylation adds another branching point, if it takes place at a secondary carbon, but adds none if it takes place on a primary carbon. Accordingly, the hydroformylation process adds about 0.3-0.4 to an average degree of branching of the isotridecanol. A higher ratio of 2-butene to 1-butene or a higher content of isobutene in the initial butene mixture will result in a higher average degree of branching and vice versa. A hydroformylation is also called oxo-synthesis and thus alcohols obtained via hydroformylation are also called oxo-alcohols. Tridecanol N (TM BASF) is described in WO 2012-139985 as a primary alcohol with an average degree of branching ranging from 2.0 to 2.4, with a molecular formula iC₁₃H₂₇OH and produced by trimerization of butene followed by hydroformylation. Marlipal O13 (TM Sasol) is a series of alkylpolyethylene glycol ethers, which are based on an isotridecanol, which itself is a hydroformylated C12-olefin mixture prepared by trimerization of n-butene. An alternative way to obtain a C12 alkene fraction is the oligomerization of a propene/butene mixture followed by distillation. Propene as the sole building block of a C12 alkene leads to a degree of branching of 3 of a resulting C12 alkene. Hydroformylation adds another 0.3 to 0.4 to the degree of branching. With a butene content in a butene/propene mixture, the average degree of branching is decreased. A propene/butene mixture is for example obtainable as an output of a steam-cracker. A propene/butene mixture leads to an oligomerized olefin mixture containing all integer numbers of carbon atoms. A normal distillation cannot cut this spectrum fine enough to obtain finally solely a C13 alcohol. Accordingly, a “C13” alcohol manufactured by this process contains C12 alcohols and C14 alcohols. Exxal 13 (TM ExxonMobil) is predominantly an isotridecanol. WO 2016-041916 describes an average degree of branching of 3 for Exxal 13.

The reaction of the first C₁₂-C₁₆ aliphatic alcohol with 10 to 20 equivalents of ethylene oxide is preferably catalyzed by NaOH, KOH, a so-called narrow range catalyst (e.g. “non-ionic surfactants: organic chemistry” in surfactant science series, vol. 72, 1998, p. 1-37 and p. 87-107, edited by Nico M. van Os, publisher Marcel Dekker Inc.) or a double metal cyanide (e.g. U.S. Pat. No. 6,429,342, WO 2000-14045 with its example 13 disclosing a reaction of Dodecanol N with ethylene oxide, WO 2004-033404 with its example 5 disclosing a reaction of 2-propylheptanol with 8 equivalents ethylene oxide). WO 2001-36356 discloses in its example 3 an ethoxylation of an isotridecanol with an average degree of branching of 2.27 by reaction with 7 equivalents ethylene oxide under pressure and sodium hydroxide as a catalyst. Its example 4 discloses an ethoxylation of an isotridecanol with an average degree of branching of 2.27 by reaction with 3 equivalents ethylene oxide under pressure and sodium hydroxide as a catalyst. The reaction between the first C₁₂-C₁₆ aliphatic alcohol and ethylene oxide is preferably conducted under a pressure above atmospheric pressure. Reaction with a certain number of equivalents of ethylene oxide refers to a molar ratio between the first C₁₂-C₁₆ aliphatic alcohol and ethylene oxide used as starting materials, e.g. if 1 mol of the first C₁₂-C₁₆ aliphatic alcohol is reacted with 10 mol of ethylene oxide, then this is expressed as reaction of the first C₁₂-C₁₆ aliphatic alcohol with 10 equivalents of ethylene oxide. Preferably, component (i) is a reaction product of a first C₁₂-C₁₆ aliphatic alcohol having an average degree of branching of 2.0 to 3.5 and 10 to 15 equivalents of ethylene oxide, more preferably 10 to 14 equivalents of ethylene oxide, very preferably 10 to 13 equivalents of ethylene oxide, particularly 10 to 12 equivalents of ethylene oxide, very particularly 10 to 11 equivalents of ethylene oxide and especially 10 equivalents of ethylene oxide. A reaction of the first C₁₂-C₁₆ aliphatic alcohol with 10 to 20 equivalents of ethylene oxide results generally in a reaction product, which contains some of the original first C₁₂-C₁₆ aliphatic alcohol and an oligomeric distribution of ethoxylated molecules, which differ by the number of incorporated oxyethylene units [═—(O—CH₂—CH₂)—].

Preferred is a method, wherein component (i) is a reaction product of the first C₁₂-C₁₆ aliphatic alcohol having an average degree of branching of 1.9 to 3.5 and 10 to 14 equivalents of ethylene oxide.

The reaction product of the first C₁₂-C₁₆ aliphatic alcohol can be expressed as a mixture, which contains molecules of the formula C₁₂-C₁₆-alkyl-(O—CH₂—CH₂-)n-OH with n=0, 1, 2, . . . , preferably n=0 or an integer from 1 to 40, more preferably n=0 or an integer from 1 to 35, very preferably n=0 or an integer from 1 to 30, particularly n=0 or an integer from 1 to 25, very particularly n=0 or an integer from 1 to 23. The formula C₁₂-C₁₆-alkyl-(O—CH₂—CH₂-)n-OH with n=0, 1, 2, . . . represents the formulae C₁₂H₂₅—(O—CH₂—CH₂—)ₙ—OH, C₁₃H₂₇—(O—CH₂—CH₂—)ₙ—OH, C₁₄H₂₉—(OCH₂—CH₂—)ₙ—OH, C₁₅H₃₁—(O—CH₂—CH₂—)ₙ—OH or C₁₆H₃₃—(O—CH₂—CH₂—)ₙ—OH with n=0, 1, 2, . . . . Often, the number of molecules from the remaining part from the starting material due to a nonethoxylation first C₁₂-C₁₆ aliphatic alcohol, i.e. C₁₂-C₁₆-alkyl-(O—CH₂—CH₂—)₀—OH, is in the reaction product higher than the number of molecules, which are mono-ethoxylated, i.e. C₁₂-C₁₆-alkyl-(OCH₂—CH₂—)₁—OH. Typically, the number of equivalents of ethylene oxide employed for the reaction product is not the number of oxyethylene units of the ethoxylated molecule, which occurs most often based on its number of molecules in the reaction product. Instead, the ethoxylated molecule, which occurs most often based on its number of molecules in the reaction product, has a value of n, which is below the number of equivalents of ethylene oxide employed for the reaction product. If the first C₁₂-C₁₆ aliphatic alcohol is a C₁₂-C₁₄ aliphatic alcohol, the reaction product of the first C₁₂-C₁₆ aliphatic alcohol can be expressed as a mixture, which contains molecules of the formulae C₁₂H₂₅—(O—CH₂—CH₂—)ₙ—OH, C₁₃H₂₇—(O—CH₂—CH₂—)ₙ—OH or C₁₄H₂₉—(O—CH₂—CH₂—)ₙ—OH with n=0, 1, 2, . . . . If the first C₁₂-C₁₆ aliphatic alcohol is an isotridecanol, the reaction product of the first C₁₂-C₁₆ aliphatic alcohol can be expressed as a mixture, which contains molecules of the formula C₁₃H₂₇—(O—CH₂—CH₂—)ₙ—OH with n=0, 1, 2, . . . .

Addition of a second C₁₂-C₁₆ aliphatic alcohol with an average degree of branching of 1.9 to 3.5 does not change the relative distribution of ethoxylated molecules in the reaction product of the first C₁₂-C₁₆ aliphatic alcohol. The addition changes the relative content of the first C₁₂-C₁₆ aliphatic alcohol in the reaction product in relation to the ethoxylated molecules, if the second C₁₂-C₁₆ aliphatic alcohol is or comprises one or more single C₁₂-C₁₆ aliphatic alcohol molecules, which are also present in the first C₁₂-C₁₆ aliphatic alcohol. This is especially the case, if the first C₁₂-C₁₆ aliphatic alcohol and the second C₁₂-C₁₆ aliphatic alcohol are the same or comprises one or more single C₁₂-C₁₆ aliphatic alcohol molecules. Thus, the blend of ethoxylated and nonethoxylated alcohols differs from component (i) by a different relative content of C₁₂-C₁₆ aliphatic alcohol molecules in relation to the ethoxylated alcohol molecules. An absolute content will always be different for each molecule of component (i) in the blend of ethoxylated and non-ethoxylated alcohols due the dilution by component (ii). For the blend, a special ratio is defined as the number of molecules of the sum of the first C₁₂-C₁₆ aliphatic alcohol and the second C₁₂-C₁₆ aliphatic alcohol in relation to the number of molecules of the sum of the first C₁₂-C₁₆ aliphatic alcohol, the second C₁₂-C₁₆ aliphatic alcohol and the ethoxylated first C₁₂-C₁₆ aliphatic alcohols and the number of molecules of the most occurring ethoxylated first C₁₂-C₁₆ aliphatic alcohol with the same number of oxy-ethylene groups in relation to the number of molecules of the sum of the first C₁₂-C₁₆ aliphatic alcohol, the second C₁₂-C₁₆ aliphatic alcohol and the ethoxylated first C₁₂-C₁₆ aliphatic alcohols. For the component (i), a special ratio is defined as the number of molecules of the first C₁₂-C₁₆ aliphatic alcohol in relation to the number of molecules of the sum of the first C₁₂-C₁₆ aliphatic alcohol and the ethoxylated first C₁₂-C₁₆ aliphatic alcohols and the number of molecules of the most occurring ethoxylated first C₁₂-C₁₆ aliphatic alcohol with the same number of oxy-ethylene groups in relation to the number of molecules of the sum of the first C₁₂-C₁₆ aliphatic alcohol and the ethoxylated first C₁₂-C₁₆ aliphatic alcohols. The blend of ethoxylated and non-ethoxylated alcohols possesses a special ratio, which is higher than a special ratio of component (i). For practical reasons, i.e. a mass spectroscopy by derivatization towards anionic species does essentially not differentiate between differently branched molecules of the same molecular formula, molecules differing only by the branching pattern are preferably grouped as one entity for the aforementioned calculation of the special ratio. In case of the second C₁₂-C₁₆ aliphatic alcohol being the same as the first C₁₂-C₁₆ aliphatic alcohol, the aforementioned calculation is more convenient. Preferably, the special ratio of the blend of ethoxylated and non-ethoxylated alcohols is above 2.5. More preferably, the special ratio is above 2.5 and below 6.0. Very preferably, the special ratio is above 2.8 and below 5.5. Particularly, the special ratio is above 3.0 and below 5.2. Very particularly, the special ratio is above 3.2 and below 5.0. Especially, the special ratio is above 3.4 and below 4.5. Very especially, the special ratio is above 3.4 and below 4.2.

Without being bound to a theory, it is believed that the specific relationship between the content of lipophilic C₁₂-C₁₆ aliphatic alcohol and the distribution of the more hydrophilic ethoxylated C₁₂-C₁₆ aliphatic alcohol molecules, especially the very hydrophilic ones, is decisive for the blend's activity of acting as a non-ionic co-collector to support or boost the flotation performance of the anionic collector, i.e. component (A).

Preferred is a method, wherein in the blend of ethoxylated and non-ethoxylated alcohols, the specific ratio between the number of molecules of the sum of the first C₁₂-C₁₆ aliphatic alcohol and second C₁₂-C₁₆ aliphatic alcohol in relation to the number of molecules of the sum of the first C₁₂-C₁₆ aliphatic alcohol, the second C₁₂-C₁₆ aliphatic alcohol and ethoxylated first C₁₂-C₁₆ alcohols and the number of molecules the most occurring ethoxylated first C₁₂-C₁₆ aliphatic alcohol with the same number of oxy-ethylene groups in relation to the number of molecules of the sum of the first C₁₂-C₁₆ aliphatic alcohol, the second C₁₂-C₁₆ aliphatic alcohol and ethoxylated first C₁₂-C₁₆ alcohols is above 2.5 and below 6.

Preferably, the blend of ethoxylated and non-ethoxylated alcohols is obtained by mixing at a temperature between 0° C. and 80° C. and atmospheric pressure, e.g. 101.325 kPa, the desired amounts of (i) and (ii), both being preferably in liquid form, preferably between room temperature and 75° C., more preferably between 35° C. and 70° C., very preferably between 40° C. and 65° C. and particularly between 45° C. and 60° C.

In the blend of ethoxylated and non-ethoxylated alcohols, the amount of component (i) is preferably 83 to 92 wt. % and the amount of component (ii) is 8 to 17 wt. %. More preferably, the amount of component (i) is 85 to 90 wt. % and the amount of component (ii) is 10 to 15 wt. %. Very preferably, the amount of component (i) is 86 to 88 wt. % and the amount of component (ii) is 12 to 14 wt. %. Particularly, the amount of component (i) is 87 wt. % and the amount of component (ii) is 13 wt. %.

Preferred is a method, wherein the amount of component (i) is 83 to 93 wt. % and the amount of component (ii) is 7 to 17 wt. %.

The component (A) of the surfactant system is added preferably in an amount of 10 to 1000 g per ton of the ore, optionally after a removing of a ferromagnetic component. The calculation is performed on basis of dry ore at the beginning of the flotation process, optionally after a removing of a ferromagnetic component. The amount is very preferably from 20 to 500 g per ton of the ore, particularly preferably from 40 to 400 g per ton of the ore, especially from 50 to 300 g per ton of the ore and very especially from 100 to 200 g.

Preferred is a method, wherein the component (A) of the surfactant system is added in an amount between 10 to 1000 g per ton of the ore.

The component (B) of the surfactant system is added preferably in an amount of 10 to 500 g per ton of the ore, optionally after a removing of a ferromagnetic component. The calculation is performed on basis of dry ore at the beginning of the flotation process, optionally after a removing of a ferromagnetic component. The amount is very preferably from 20 to 300 g per ton of the ore, particularly preferably from 30 to 250 g per ton of the ore, especially from 40 to 200 g per ton of the ore and very especially from 50 to 150 g.

Preferred is a method, wherein the component (B) of the surfactant system are added in an amount between 10 to 500 g per ton of the ore.

The weight ratio between component (A), i.e. the fatty acid, and component (B), i.e. the blend of ethoxylated and non-ethoxylated alcohols, is preferably from 1 to 3, more preferably from 1.2 to 2.5, very preferably from 1.2 to 2 and particularly from 1.4 to 1.8.

Preferred is a method, wherein the weight ratio between component (A) and component (B) is from 1 to 3.

Preferably, the component (A) and (B) are added as an aqueous composition. The aqueous composition has preferably a concentration of the sum of components (A) and (B) from 0.5 to 10 wt. %, more preferably from 0.7 to 5 wt. %, very preferably from 0.9 to 3 wt. % and particularly from 1.1 to 2 wt. %.

The pH value at the steps (c) and (d) of the method is preferably adjusted with a pH regulator to a specific pH value, typically to a pH value between 8 and 11, particularly between 8.5 and 10.

A pH regulator is typically a strong base, for example sodium hydroxide, potassium hydroxide, sodium carbonate or potassium carbonate. Preferably, the pH value of the aqueous pulp is between 7 and 11, particularly between 8.5 and 10. Preferably, step (c), i.e. adding the compound of formula to the aqueous pulp, takes place at a pH value between 8 and 11, particularly between 8.5 and 10. Preferably, the pH value of the aqueous mixture is between 8 and 11, particularly between 8.5 and 10. Preferably, step (d), i.e. aerating the aqueous mixture, takes place at a pH value between 8 and 11, particularly between 8.5 and 10. A regulation of the pH value supports that the ore, especially the particles of the ore, exhibit the correct surface charge.

Preferred is a method, wherein the pH value at step (c) is between 8 and 11.

Preferred is a method, wherein the pH value at step (c) and at step (b) is between 8 and 11.

Preferred is a method, wherein the pH value at step (c) and at step (d) is between 8 and 11.

Preferred is a method, wherein the pH value at step (c), at step (b) and at step (d) is between 8 and 11.

A flotation auxiliary is for example a depressing agent, a froth regulator, a further anionic surfactant different to component (A), a further non-ionic co-collector different to components (i) or (ii) or an extender oil.

A depressing agent helps to prevent flotation of an ingredient of the ore, which is not desired to get part of the froth or supports in general the selectivity of the method of manufacturing the concentrate. A depressing agent is for example a hydrophilic polysaccharide, particularly a starch, or an alkaline metal silicate. The starch is for example a native starch or a modified starch. A native starch is for example a starch from corn, wheat, oat, barley, rice, millet, potato, pea, tapioca or manioc. The native starch is preferably pregelatinized, i.e. warmed for starch gelatination. A modified starch is either a degraded starch, which possesses a reduced weight-average molecular weight versus the original starch, a chemically modified starch or a degraded and chemically modified starch. A degradation of starch is for example possible by oxidation or treatment by acid, base or enzymes. The degradation leads typically to an increased content on oligosaccharides or dextrines. A chemical modification is a functionalization of a starch by covalent linkage of a chemical group to the starch. A chemically modified starch is for example obtainable by esterification or etherification of a starch. The esterification of an acid with a starch is for example performed with an anhydride of the acid or a chloride of the acid. The etherification of a starch is for example possible with an organic reagent, which contains a reactive epoxide functionality. Preferred is a depressing agent, which is a native starch, particularly a pregelatinized starch. The alkaline metal silicate, sometimes referred to as liquid glass, is preferably sodium or potassium silicate, more preferably sodium silicate. The sodium or potassium silicate is manufactured for example by a reaction of Na₂CO₃ or K₂CO₃ with SiO₂ in a molar ratio between 0.5 and 2:1 in a furnace at a temperature above 700° C., followed by cooling down and preparing an aqueous solution containing between 20 and 50 wt. % of the reaction product in water. Na₂CO₃ is a particularly preferred alkaline metal carbonate. A depressing agent is preferably added in an amount of 50 to 3000 g per ton of the ore, optionally after a removing of a ferromagnetic component. The calculation is performed on basis of dry ore at the beginning of the flotation process, optionally after a removing of a ferromagnetic component. More preferably, the depressing agent is added in an amount of 100 to 2000 g. In case of starch as a depressing agent, the amount is very preferably from 300 to 1700 g and particularly from 600 g to 1400 g. In case of an alkaline metal silicate, especially sodium silicate, the amount is very preferably from 150 g to 500 g and particularly from 200 g to 400 g.

A froth regulator helps to improve the efficiency of the method of manufacturing by interfering with the froth generation. A froth property is for example the froth height respectively the volume of the froth or the stability of the froth, i.e. the time to collapse after stop of aerating. A froth regulator is different to components (A), (i) or (ii) and is for example pine oil, methylisobutyl carbinol, C₆-C₁₁ alcohol, particularly 2-ethylhexanol or hexanol, an alcoholic ester, particularly a mixture comprising 2,2,4-trimethyl-1,3-pentandiolmonoisobutyrate, terpineol, triethoxybutane, an alkoxylated alcohol, particularly an ethoxylated and/or propoxylated alcohol, polyethylene glycol or polypropylene glycol.

A further anionic surfactant different to component (A) is for example an alkyl sulfate, an alkyl benzene sulfate, an alkyl sulfonate, an alkyl sulfosuccinate, an alkyl sulfosuccinamate, a phosphate mono- or diester or an acyl lactylate. In case of the further anionic surfactant as a flotation auxiliary, the further anionic surfactant might be added together with the components (A) and (B) of the surfactant system. In this case, this part of step (b) occurs simultaneously with step (c).

A further non-ionic co-collector is a surface-active compound, which is different to components (i) or (ii). A further non-ionic co-collector is for example an ethoxylated alkyl phenol, a C₉-C₁₅ alkyl alcohol, which is branched, an ethoxylated C₉-C₁₅ alkyl alcohol, which is branched, or a ethoxylated and propoxylated C₉-C₁₅ alkyl alcohol, wherein the alkyl moiety is branched. In case of the further non-ionic co-collector as a flotation auxiliary, the further non-ionic co-collector might be added together with the components (A) and (B) of the surfactant system. In this case, this part of step (b) occurs simultaneously with step (c).

Preferably, the method is free of an addition of a reaction product of the first C₁₂-C₁₆ aliphatic alcohol having an average degree of branching of 1.9 to 3.5 and 1 to 9 equivalents of ethylene oxide. More preferably, the method is free of an addition of a reaction product of a C₁₂-C₁₆ aliphatic alcohol having an average degree of branching of 1.9 to 3.5 and 1 to 9 equivalents of ethylene oxide. Very preferably, the method is free of an addition of a reaction product of a C₁₂-C₁₆ aliphatic alcohol having an average degree of branching of 1.9 to 3.5 and ethylene oxide, which is different to component (i). Particularly, the method is free of an addition of a reaction product of a C₁₂-C₁₆ aliphatic alcohol having an average degree of branching of 1 to 3.5 and ethylene oxide, which is different to component (i). Very particularly, the method is free of an addition of a reaction product of a C₁₂-C₁₆ aliphatic alcohol, which is branched, and ethylene oxide, which is different to component (i). Especially, the method is free of an addition of a reaction product of a C₁₂-C₁₆ aliphatic alcohol and ethylene oxide, which is different to component (i).

An extender oil is for example kerosene.

Preferred is a method, wherein at step (b) one or more flotation auxiliaries are added and one of the flotation auxiliaries is a depressing agent, a froth regulator, a further anionic surfactant different to component (A), a further non-ionic co-collector different to components (i) or (ii) or an extender oil.

Preferred is a method, wherein one of the flotation auxiliaries added at step (b) is a depressing agent.

Preferred is a method, wherein one of the flotation auxiliaries added at step (b) is a depressing agent, which is sodium silicate.

Preferred is a method, wherein one of the flotation auxiliaries added at step (b) is a depressing agent and one of the flotation auxiliaries is a further non-ionic co-collector, which is added at step (b) before step (c) or is added simultaneously with components (A) and (B) of the surfactant system.

In the method of manufacturing a concentrate, conventional flotation plant equipment may be used. Preferably, the components (A) and (B) of the surfactant system and optionally a flotation auxiliary are added to the aqueous pulp, which is already in the flotation cell, which is used for aerating the mixture in step (d).

After adding of the components (A) and (B) of the surfactant system to the aqueous pulp, the obtained aqueous mixture is preferably kept, particularly under stirring, for a conditioning period before aerating the aqueous mixture. This allows the surfactant system and optionally a flotation auxiliary to condition the ore, particularly the ore particles, in the aqueous mixture. The conditioning period lasts for example for one minute or up to 10 or 15 minutes.

At aerating the aqueous mixture, air is typically injected into the base of the flotation cell. Air bubbles are formed and rise to the surface and generate the froth at the surface. The injection of air may be continued until no more froth is formed. This might last for example for one minute or up to 15 or 20 minutes. The froth is removed.

In some cases, it may be desirable to treat the concentrate enriched in phosphate mineral content in a similar manner again. For example, the steps (c), (d) and (e) are repeated as step (e-c) followed by step (e-d) and afterwards by step (e-e).

The above described preferences for the method of manufacturing a concentrate or for the added surfactant system are described for the method. These preferences apply also to the further embodiments of the invention.

A further embodiment of the invention is a use of a surfactant system comprising components
(A) a fatty acid,
(B) a blend of ethoxylated and non-ethoxylated alcohols, which is obtainable by blending components
   (i) a reaction product of a first C₁₂-C₁₆ aliphatic alcohol having an average degree of branching of 1.9 to 3.5 and 10 to 20 equivalents of ethylene oxide, and
   (ii) a second C₁₂-C₁₆ aliphatic alcohol having an average degree of branching of 1.9 to 3.5,
   wherein the amount of (i) is 80 to 95 wt. % and the amount of (ii) is 5 to 20 wt. % and wt. % is based on the overall weight of the mixture of ethoxylated and non-ethoxylated alcohols

as a flotation collector for manufacturing a concentrate enriched in phosphate mineral content from an ore, which contains a phosphate mineral and a non-phosphate mineral, by a flotation.

The component (A) acts as an anionic collector. Component (B) acts as a non-ionic co-collector, i.e. component (B) supports or boosts the performance of component (A) as an anionic collector.

A further embodiment of the invention is a blend of ethoxylated and non-ethoxylated alcohols, which is obtainable by blending components
(i) a reaction product of a first C₁₂-C₁₆ aliphatic alcohol having an average degree of branching of 1.9 to 3.5 and 10 to 20 equivalents of ethylene oxide, and
(ii) a second C₁₂-C₁₆ aliphatic alcohol having an average degree of branching of 1.9 to 3.5,
wherein the amount of (i) is 80 to 95 wt. % and the amount of (ii) is 5 to 20 wt. % and wt. % is based on the overall weight of the mixture of ethoxylated and non-ethoxylated alcohols.

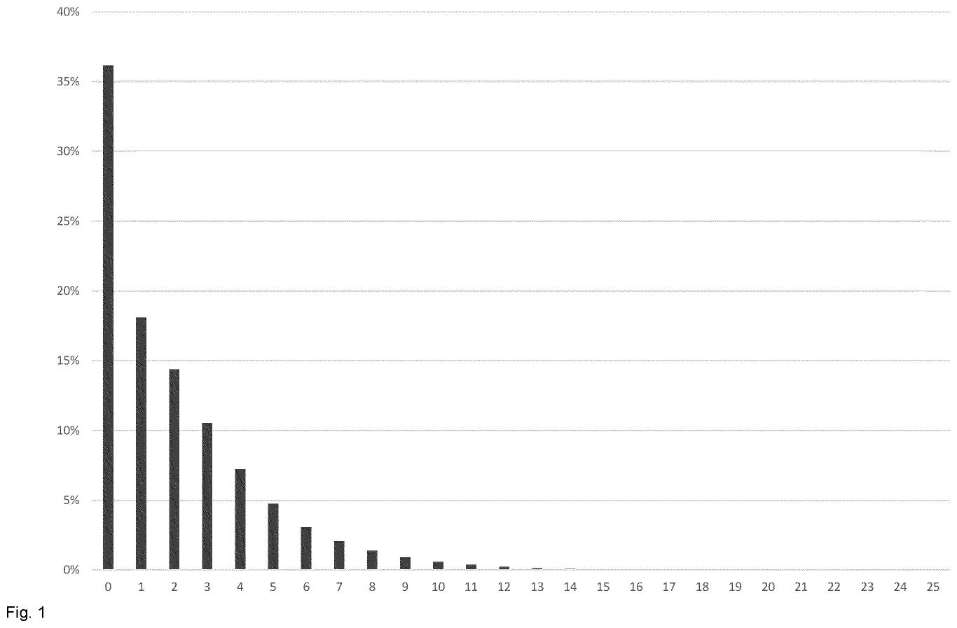

FIGS. 1 to 4 are attached and described below.

FIG. 1 shows a distribution of relative ESI MS signal intensities in percentage on y-axis versus ethoxylation numbers of the phthalic acid mono ester component on x-axis of the derivatized material from A-2 [“iC₁₃-3EO”].

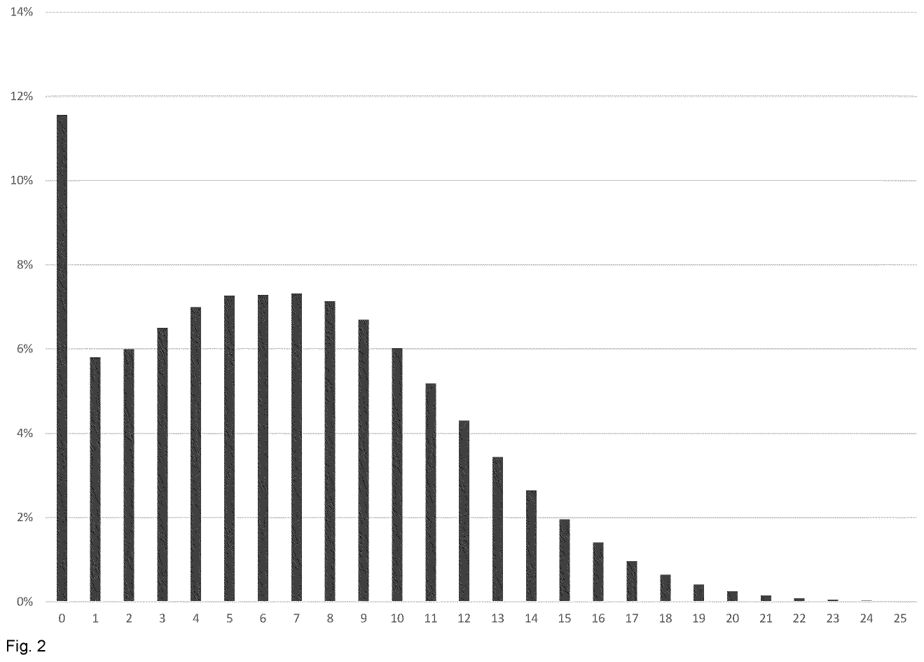

FIG. 2 shows a distribution of relative ESI MS signal intensities in percentage on y-axis versus ethoxylation numbers of the phthalic acid mono ester component on x-axis of the derivatized material from A-3 [“iC₁₃-10EO”].

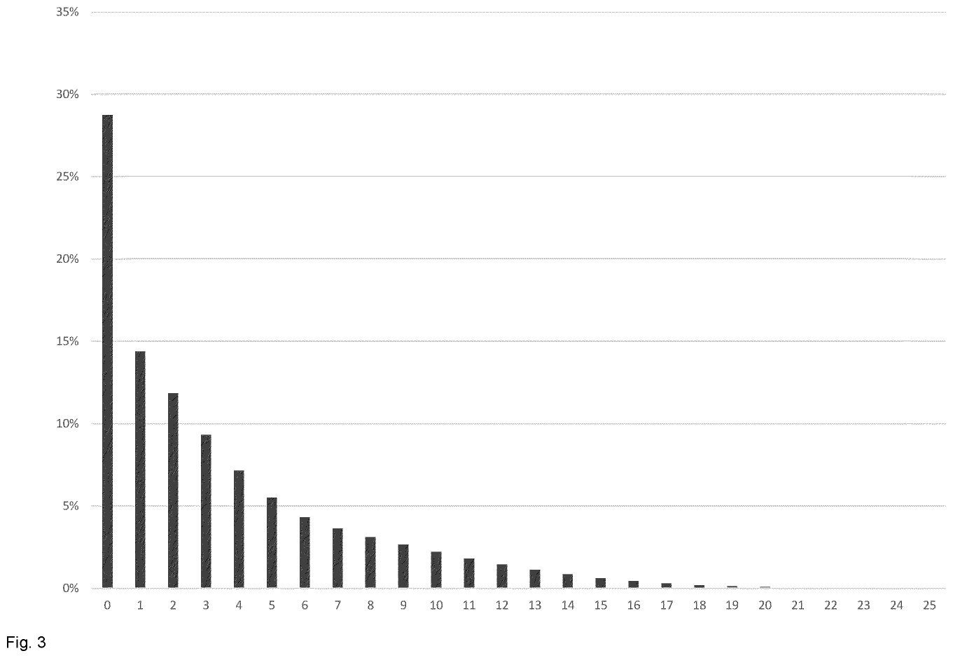

FIG. 3 shows a distribution of relative ESI MS signal intensities in percentage on y-axis versus ethoxylation numbers of the phthalic acid mono ester component on x-axis of the derivatized material from A-4 [“0.4 iC₁₃-3EO+0.6 iC₁₃-10EO”].

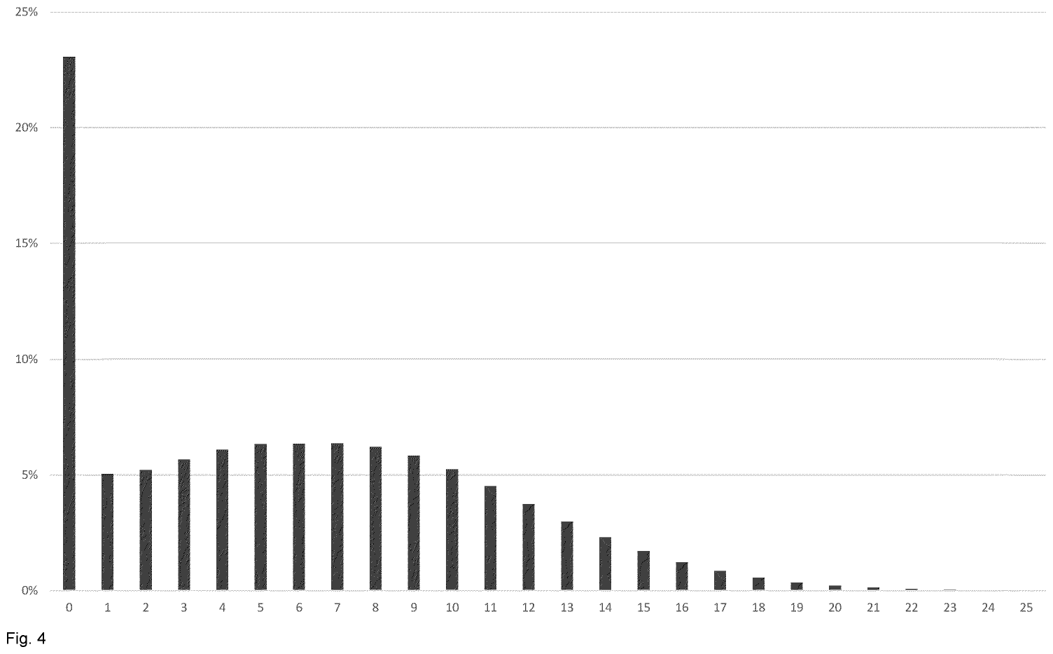

FIG. 4 shows a distribution of relative ESI MS signal intensities in percentage on y-axis versus ethoxylation numbers of the phthalic acid mono ester component on x-axis of the derivatized material from A-5 [“0.13 iC₁₃-0EO+0.87 iC₁₃-10EO”].

The following examples illustrate further the invention without limiting it. Percentage values are percentage by weight if not stated differently. Part values are parts by weight if not stated differently.

A) Isotridecanol, its Ethoxylates and Mixtures Thereof

A-1 (comparative): isotridecanol with an average degree of branching of 2.2 [“iC₁₃-OEO”], which is obtained by oligomerizing a butene isomer mixture, separating out a trimer fraction and hydroformylating the separated trimer fraction.

The ethoxylation reaction at A-2 and A-3 is conducted in a pressurized reactor using a double metal cyanide (DMC) catalyst.

A-2 (comparative): reaction product containing A-1 and isotridecanol ethoxylates obtained by reaction of A-1 with 3 equivalents of ethylene oxide [“iC₁₃-3EO” ]

Percentage of molecule numbers of single components are provided as described under B) by transfer.

Relative intensity of A-1, i.e. iC₁₃—(O—CH₂CH₂)₀—OH: 36.2%

Relative intensity of the most intensive ethoxylated component, i.e. iC₁₃—(O—CH₂CH₂)₁—OH:

18.1%

36.2% divided by 18.1%: 2.0

A-3 (comparative): reaction product containing A-1 and isotridecanol ethoxylates obtained by reaction of A-1 with 10 equivalents of ethylene oxide [“iC₁₃-10EO” ]

Percentage of molecule numbers of single components are provided as described under B) by transfer.
relative intensity of A-1, i.e. iC₁₃—(O—CH₂CH₂)₀—OH: 11.6%
relative intensity of the most intensive ethoxylated component, i.e. iC₁₃—(O—CH₂CH₂)₅—OH or iC₁₃—(O—CH₂CH₂)s-OH or iC₁₃—(O—CH₂CH₂)₇—OH: 7.3%
11.6% divided by 7.3%: 1.6

A-4 (comparative): blend of 4 parts of A-2 and 6 parts of A-3 obtained by mixing of 4 parts of A2 and 6 parts of A-3 [“0.4 iC₁₃-3EO+0.6 iC₁₃-10EO” ]

Percentage of molecule numbers of single components are provided as described under B) by transfer.
relative intensity of A-1, i.e. iC₁₃—(O—CH₂CH₂)₀—OH: 28.7%
relative intensity of the most intensive ethoxylated component, i.e. iC₁₃—(O—CH₂CH₂)₁—OH: 14.4%
28.7% divided by 14.4%: 2.0

A-5 (according to invention): blend of 1.3 parts of A-1 and 8.7 parts of A-3 obtained by mixing of 1.3 parts of A-1 and 8.7 parts of A-3 [“0.13 iC₁₃-0EO+0.87 iC₁₃-10EO” ]

Percentage of molecule numbers of single components are provided as described under B) by transfer.
relative intensity of A-1, i.e. iC₁₃—(O—CH₂CH₂)₀—OH: 23.1%
relative intensity of the most intensive ethoxylated component, i.e. iC₁₃—(O—CH₂CH₂)₇—OH: 6.4%
23.1% divided by 6.4%: 3.6

B) Mass Spectroscopy of Alcoholic Components

ESI MS (electro spray ionization mass spectroscopy) analysis of derivatized A-2, A-3, A-4 and A-5 is determined for a quantitative fractional distribution of non-ethoxylated and ethoxylated isotridecanol components. The hydroxyl functional groups of the non-ethoxylated and ethoxylated isotridecanol components are derivatized with phthalic anhydride to overcome the ESI discrimination of the low molecular weight components and the problem of multiple charged formation of the higher molecular weight components of ethoxylated alcohols in the positive ionization mode. A sample is derivatized with a derivatizating solution, which consists of 1 M phthalic anhydride and pyridine in acetonitrile. 50 μL of the sample is added into 1 mL derivatizating solution. Afterwards, this mixture is kept at 100° C. for 2 h. After cooling down to room temperature, 50 μL of the mixture is diluted with 950 μL acetonitrile. An aliquot is injected in a HPLC (high pressure liquid chromatography) MS, equipped with a combination of XSelect HSS PFP (150×3 mm, 3.5 μm) and LiChrospher 100 RP 8 (125×3 mm, 5 μm) (TM Merck) using a water methanol gradient with 0.1% formic acid as modifier. The column oven is set to 50° C. The derivatized components are detected with a high-resolution mass spectrometer using electrospray ionization in negative mode. The resulting carboxylate derivatives iC₁₃—(O—CH₂CH₂)ₙ—O—(COC₆H₄—COOH) with n=0, 1, 2, . . . are measured in the negative ionization mode without the above-mentioned issues. The derivatization scheme of iC₁₃(O—CH₂—CH₂)ₙ—OH with n=0, 1, 2, . . . is depicted below

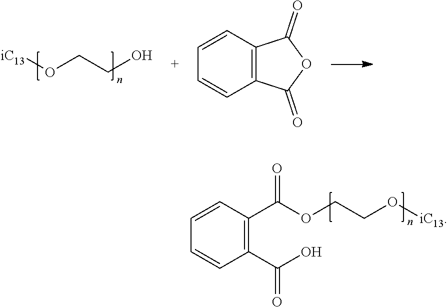

The advantage of introducing a negative charge by derivatization is that the response factor for every component of the distribution is the same. Dividing the absolute ESI MS signal intensity for a component by the sum of all absolute ESI MS signal intensities provides a relative ESI MS signal intensity for the component, which is stated as percentage. Accordingly, a relative ESI MS signal intensity for a component correlates to the number of all molecules of the component in relation to the number of all molecules of all components. With a derivatization being quantitative or at least not discriminating between different amounts of ethoxy-units in a molecule, the calculated relative ESI MS signal intensity for the phthalic acid mono ester can be transferred to the correlations of non-derivatized components iC₁₃—(O—CH₂CH₂)ₙ—OH with n=0, 1, 2, . . . .

FIG. 1 to FIG. 4 depict distributions of relative ESI MS signal intensities in percentage on y-axis versus ethoxylation numbers of the phthalic acid mono ester components on x-axis of the derivatized material from A-2 to A-5.

FIG. 1 depicts the ESI MS signal intensities of the phthalic acid mono esters of the alcoholic components of A-2.

Relative intensity of the phthalic acid mono ester of A-1, i.e. iC₁₃—(O—CH₂CH₂)₀—O—(CO—C₆H₄—COOH)):

36.2%

Relative intensity of the most intensive phthalic acid mono ester of an ethoxylated component, i.e. iC₁₃—(O—CH₂CH₂)₁—O—(CO—C₆H₄—COOH): 18.1%

36.2% divided by 18.1%: 2.0

FIG. 2 depicts the ESI MS signal intensities of the phthalic acid mono esters of the alcoholic components of A-3 as described under B).

Relative intensity of the phthalic acid mono ester of A-1, i.e. iC₁₃—(O—CH₂CH₂)₀—OH: 11.6%

Relative intensity of the most intensive phthalic acid mono ester of an ethoxylated component, i.e. iC₁₃—(O—CH₂CH₂)₅—O—(CO—C₆H₄—COOH) or iC₁₃—(O—CH₂CH₂)₆—O—(CO—C₆H₄—COOH) or iC₁₃—(OCH₂CH₂)₇—O—(CO—C₆H₄—COOH): 7.3%

11.6% divided by 7.3%: 1.6

FIG. 3 depicts the ESI MS signal intensities of the phthalic acid mono esters of the alcoholic components of A-4 as described under B).

Relative intensity of the phthalic acid mono ester of A-1, i.e. iC₁₃—(O—CH₂CH₂)₀—O—(CO—C₆H₄—COOH):

28.7%

Relative intensity of the most intensive phthalic acid mono ester of an ethoxylated component, i.e. iC₁₃—(O—CH₂CH₂)₁—O—(CO—C₆H₄—COOH): 14.4%

28.7% divided by 14.4%: 2.0

FIG. 4 depicts the ESI MS signal intensities of the phthalic acid mono esters of the alcoholic components of A-5 as described under B).

Relative intensity of the phthalic acid mono ester of A-1, i.e. iC₁₃—(O—CH₂CH₂)₀—O—(CO—C₆H₄—COOH):

23.1%

Relative intensity of the most intensive phthalic acid mono ester of an ethoxylated component, i.e. iC₁₃—(O—CH₂CH₂)₇—O—(CO—C₆H₄—COOH): 6.4% 23.1% divided by 6.4%: 3.6

TABLE B-1
numerical values of A-2 to A-5 at FIG. 1 to FIG. 4

relative intensity [%]

| ethoxylation | A-2 ^{a)} | A-3 ^{a)} | A-4 ^{a)} | A-5 ^{b)} |
|---|---|---|---|---|
| number | (FIG. 1) | (FIG. 2) | (FIG. 3) | (FIG. 4) |
| 0 | 36.2 | 11.6 | 28.7 | 23.1 |
| 1 | 18.1 | 5.8 | 14.4 | 5.0 |
| 2 | 14.4 | 6.0 | 11.9 | 5.2 |
| 3 | 10.5 | 6.5 | 9.3 | 5.7 |
| 4 | 7.2 | 7.0 | 7.1 | 6.1 |
| 5 | 4.8 | 7.3 | 5.5 | 6.3 |
| 6 | 3.1 | 7.3 | 4.3 | 6.3 |
| 7 | 2.0 | 7.3 | 3.6 | 6.4 |
| 8 | 1.4 | 7.1 | 3.1 | 6.2 |
| 9 | 0.9 | 6.7 | 2.7 | 5.8 |
| 10 | 0.6 | 6.0 | 2.2 | 5.2 |
| 11 | 0.4 | 5.2 | 1.8 | 4.5 |
| 12 | 0.2 | 4.3 | 1.5 | 3.7 |
| 13 | x ^{c)} | 3.4 | 1.1 | 3.0 |
| 14 | | 2.0 | 0.8 | 2.3 |
| 15 | | 2.0 | 0.6 | 1.7 |
| 16 | | 1.4 | 0.4 | 1.2 |
| 17 | | 1.0 | 0.3 | 0.8 |
| 18 | | 0.6 | 0.2 | 0.6 |
| 19 | | 0.4 | x ^{c)} | 0.4 |
| 20 | | 0.2 | | 0.2 |
| 21 | | x ^{c)} | | x ^{c)} |

Footnotes:
^{a)} comparative
^{b)} according to invention
^{c)} numerical values below 0.2% not listed

C) flotation

In a continuous flotation process, apatite is enriched by flotation from an ore feed containing an equivalent of 7.5% P₂O₅ as fluorapatite, and 11% CO₂ as calcite and dolomite, ground to 38% passing a 71 μm sieve (80% passing 200 μm sieve). In the continuous beneficiation process, the ore is being wet ground in a ball mill to the desired size, followed by a wet magnetic separation to remove ferromagnetic components (primarily magnetite Fe₃O₄). The non-magnetic residue is conditioned as an aqueous pulp containing 1000 parts of solids and 1000 parts of water (the approximate ionic content of the water is provided in table C-1) as well as 0.36 parts of sodium carbonate, 0.28 parts of sodium silicate as a depressant, 0.06 parts of a heavy distillation fraction from the industrial manufacturing of 2-ethylhexanol as a froth regulator, 0.15 parts of distilled tall oil fatty acid from northern pine wood as the main collector as well as an amount of a co-collector, i.e. 0.145 parts or 0.128 parts as indicated in table C-2. The distilled tall oil fatty acid and the co-collector are mixed and diluted with water (the approximate ionic content of the water is provided in table C-1) to a concentration of 1.5 wt. % before addition. The ore slurry is subjected to froth flotation in a continuous process consisting of a two rougher stages, two cleaner stages and two scavengers with an average residence time of 4 min. The pH is controlled at 9 by adding sodium carbonate as a solution. The collector and co-collector are primarily added to the rougher stage, although a part of the collector and co-collector addition is diverted to the scavenger stage if needed. Water is circulated in the process (the approximate ionic content of the water is provided in table C-1). The mass throughput of concentrate of the second cleaner stage as well as of the final flotation tailings is determined via ultrasonic mass flow detectors, while the phosphate content is determined by generating a borate fluxed pellet and determining phosphorus content of the pellet from the characteristic X-ray fluorescence signal from which the concentrate grade can be calculated as wt. % (P₂O₅). Data are taken every 3 hours for tailings, concentrate and intermediate fractions. The process control is achieved by a skilled person interpreting the data and changing the collector, co-collector and depressant addition until a steady state is reached. After the process reached the steady state, the data are averaged over a period of 11 days. From these data, an average phosphate recovery is calculated with a reliability far exceeding the data obtained in a single lab scale test, since minor deviations resulting from fluctuations in ore compositions or process parameter variations are averaged out. Results are provided in table C-2.

TABLE C-1
approximate ionic content of the applied water

| dissolved | suspended | | | | carbonates | | |
|---|---|---|---|---|---|---|---|
| solids | solids | pH | Ca²⁺ | Mg²⁺ | including HCO₃⁻ | SO₄²⁻ | Cl⁻ |
| 740 mg/L | 15 mg/L | 9 | 24 mg/L | 30 mg/L | 350 mg/L | 240 mg/L | 9 mg/L |

TABLE C-2
flotation with recovery and grade

| | | amount of | distilled tall | | |
|---|---|---|---|---|---|
| | | co-collector | oil fatty acids | recovery of | |
| | | [wt. % based | [wt. % based | P₂O₅ in | grade of |
| | | on dry ore after | on dry ore after | concentrate | concentrate |
| example | co-collector | magnetic separation] | magnetic separation] | [%] | [wt. % P₂O₅] |
| C-2-1 ^{a)} | A-4 | 0.0145 | 0.015 | 76.8 | 37.1 |
| | [“0.4 iC₁₃-3EO + | | | | |
| | 0.6 iC₁₃-10EO”] | | | | |
| C-2-2 ^{b)} | A-5 | 0.0128 | 0.015 | 77.7 | 36.9 |
| | [“0.13 iC₁₃-0EO + | | | | |
| | 0.87 iC₁₃-10EO”] | | | | |

Footnotes:
^{a)} comparative
^{b)} according to invention

The results in table C-2 shows at example C-2-2 an increase in average phosphate recovery by 1.1% units versus example C-2-1 at a nearly constant concentrate grade. Furthermore, the amount of co-collector is at the same time reduced by 10% versus example C-2-1.

I/We claim:

1. A method for manufacturing a concentrate enriched in phosphate mineral content from an ore, wherein the ore contains a phosphate mineral and a nonphosphate mineral, by a flotation, comprising:
(c) adding a surfactant system comprising components:
(A) a fatty acid,
(B) a blend of ethoxylated and non-ethoxylated alcohols, which is obtainable by blending components
(i) a reaction product of a first C₁₂-C₁₆ aliphatic alcohol having an average degree of branching of 1.9 to 3.5 and 10 to 20 equivalents of ethylene oxide, and
(ii) a second C₁₂-C₁₆ aliphatic alcohol having an average degree of branching of 1.9 to 3.5,
wherein the amount of (i) is about 80 wt. % to about 95 wt. % and the amount of (ii) is about 5 wt. % to about 20 wt. % and wt. % is based on the overall weight of the mixture of ethoxylated and non-ethoxylated alcohols,
to a prepared aqueous pulp of the ore and optionally one or more flotation auxiliaries to obtain an aqueous mixture.

2. The method according to claim 1, further comprising:
(a) providing the ore, wherein the ore contains the phosphate mineral and the non-phosphate mineral;
(b) preparing from the provided ore by addition of water and optionally one or more flotation auxiliaries an aqueous pulp; and
(d) aerating the aqueous mixture in a flotation cell to generate a froth, wherein the froth contains the concentrate enriched in phosphate mineral content.

3. The method according to claim 1, wherein the weight ratio between component (A) and component (B) is about 1 to about 3.

4. The method according to claim 1, wherein the amount of (i) is 83 to 93 wt. % and the amount of (ii) is 7 to 17 wt. %.

5. The method according to claim 1, wherein component (i) is a reaction product of the first C₁₂-C₁₆ aliphatic alcohol having an average degree of branching of 1.9 to 3.5 and 10 to 14 equivalents of ethylene oxide.

6. The method according to claim 1, wherein the average degree of branching of the first C₁₂-C₁₆ aliphatic alcohol is between 2.0 and 2.5.

7. The method according to claim 1, wherein the first C₁₂-C₁₆ aliphatic alcohol and the second C₁₂-C₁₆ aliphatic alcohol are the same C₁₂-C₁₆ aliphatic alcohol.

8. The method according to claim 1, wherein in the blend of ethoxylated and non-ethoxlyated alcohols, the specific ratio between the number of molecules of the sum of the first C₁₂-C₁₆ aliphatic alcohol and second C₁₂-C₁₆ aliphatic alcohol in relation to the number of molecules of the sum of the first C₁₂-C₁₆ aliphatic alcohol, the second C₁₂-C₁₆ aliphatic alcohol and ethoxylated first C₁₂-C₁₆ alcohols and the number of molecules of the most occurring ethoxylated first C₁₂-C₁₆ aliphatic alcohol with the same number of oxyethylene groups in relation to the number of molecules of the sum of the first C₁₂-C₁₆ aliphatic alcohol, the second C₁₂-C₁₆ aliphatic alcohol and ethoxylated first C₁₂-C₁₆ alcohols is above 2.5 and below 6.

9. The method according to claim 1, wherein the first C₁₂-C₁₆ aliphatic alcohol is isotridecanol.

10. The method according to claim 1, wherein component (A) is added in an amount between 10 g to 1000 g per ton of the ore.

11. The method according to claim 1, wherein component (B) is added in an amount between 10 g to 500 g per ton of the ore.

12. The method according to claim 1, wherein the pH value at step (c) is between 8 and 11.

13. The method according to claim 1, wherein at step (b) one or more flotation auxiliaries are added and one of the flotation auxiliaries is a depressing agent, a froth regulator, a further anionic surfactant different to component (A), a further nonionic co-collector different to components (i) or (ii) or an extender oil.

14. The method according to claim 13, wherein one of the flotation auxiliaries is a depressing agent, which is sodium silicate.

15. A method of using a surfactant system comprising components
(A) a fatty acid,
(B) a blend of ethoxylated and non-ethoxylated alcohols, which is obtainable by blending components
(i) a reaction product of a first C₁₂-C₁₆ aliphatic alcohol having an average degree of branching of 1.9 to 3.5 and 10 to 20 equivalents of ethylene oxide, and
(ii) a second C₁₂-C₁₆ aliphatic alcohol having an average degree of branching of 1.9 to 3.5,
wherein the amount of (i) is about 80 wt. % to about 95 wt. % and the amount of (ii) is about 5 wt. % to about 20 wt. % and wt. % is based on the overall weight of the mixture of ethoxylated and non-ethoxylated alcohols,
as a flotation collector for manufacturing a concentrate enriched in phosphate mineral content from an ore, which contains a phosphate mineral and a non-phosphate mineral, by a flotation.

16. A blend of ethoxylated and non-ethoxylated alcohols, comprising a reaction product of:
(i) a first C₁₂-C₁₆ aliphatic alcohol having an average degree of branching of 1.9 to 3.5 and 10 to 20 equivalents of ethylene oxide, and
(ii) a second C₁₂-C₁₆ aliphatic alcohol having an average degree of branching of 1.9 to 3.5,
wherein the amount of (i) is 80 to 95 wt. % and the amount of (ii) is 5 to 20 wt. % and wt. % is based on the overall weight of the mixture of ethoxylated and non-ethoxylated alcohols.
